(19) United States
(12) Patent Application Publication
(10) Pub. No.: US 2026/0331324 A1
(43) Pub. Date: Oct. 22, 2026

(54) PRODUCING RADIONUCLIDES BY HIGH INTENSITY BEAMS OF LIGHT IONS

(71) Applicant: CVF International LLC, New York, NY (US)

(72) Inventors: Aleksandr KLACHKOV, Moscow Oblast (RU); Pavel MOSEEV, Moscow (RU); Roman TERTYCHNYY, Moscow Oblast (RU); Aleksandr KHASIN, Ness Ziona (IL)

(73) Assignee: CVF International LLC, New York, NY (US)

(21) Appl. No.: 19/242,377

(22) Filed: Jun. 18, 2025

Related U.S. Application Data
(60) Provisional application No. 63/661,825, filed on Jun. 19, 2024.

(51) Int. Cl. G21G 1/10

(52) U.S. Cl. CPC G21G 1/10

(57) ABSTRACT

Irradiation targets, systems and methods are provided for producing radionuclides by irradiation of the target with ions from a particle accelerator. Irradiation targets comprise a metallic layer enriched with a specific metal isotope, a base plate supporting the metallic layer, and an isolating layer covering the metallic layer on the base plate by at most 3μm of a deposited metal having a low vapor pressure. The base plate is made of a metal or metal alloy that has a high thermal conductivity, and the irradiation target is configured to be set within a case of an irradiation device that irradiates the metallic layer thereof with the ions. Methods and systems of producing the irradiation targets and processing the targets after their irradiation are further provided.

### CROSS REFERENCE TO RELATED APPLICATIONS

This application claims priority from U.S. Provisional Application No. 63/661,825, filed on Jun. 19, 2024, which is incorporated herein by reference in its entirety.

### BACKGROUND OF THE INVENTION

### 1. Technical Field

The present invention relates to the field of nuclear engineering, and more particularly, to producing radionuclides.

### 2. Discussion of Related Art

U.S. Pat. No. 10,249,399, which is incorporated herein by reference in its entirety, teaches methods for producing of high quantities (multiple Curie) of astatine-211 with high power proton beam irradiation of a thorium target.

U.S. Pat. No. 11,335,473, which is incorporated herein by reference in its entirety, teaches methods for production of radionuclides, including specifically astatine, in the target, where the target nuclide (material) is encapsulated with the foil.

U.S. Patent Application Publication No. 2007/0297554, which is incorporated herein by reference in its entirety, teaches methods for production radioisotopes, in which the high heat flux is removed from the target in the process of irradiation.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides an irradiation target for producing a radionuclide by irradiation thereof with ions from a particle accelerator, the irradiation target comprising: a metallic layer comprising a first metal enriched with a specific metal isotope, a base plate supporting the metallic layer, and an isolating layer covering the metallic layer on the base plate by at most 3 μm of a deposited second metal that has a vapor pressure below 1 Pa at 1200 °C, wherein the base plate has a front surface that supports the metallic layer and a back surface, and is made of a third metal or metal alloy that has a thermal conductivity above 150 W/(m·K), and wherein the irradiation target is configured to be set within a case of an irradiation device that irradiates the metallic layer thereof with the ions.

One aspect of the present invention provides a method of producing radionuclides, the method comprising irradiating the disclosed irradiation targets with ions from a particle accelerator, and extracting the radionuclides from the irradiated targets.

One aspect of the present invention provides a system of producing radionuclides, the system comprising an irradiation device comprising a vacuum chamber enclosing the disclosed irradiation targets, and a particle accelerator providing ions into the irradiation device for irradiating the target.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic block diagram of using an irradiation target, according to some embodiments of the invention.

FIG. 2 is a high-level schematic illustration of using the target to produce radionuclides, according to some embodiments of the invention.

FIG. 3 is a high-level schematic illustration of possible implementations of the process of forming or depositing the isolating layer, according to some embodiments of the invention.

FIG. 4 is a high-level schematic illustration of possible implementations of forming the material for the irradiation target layer by evaporation and deposition (i.e. sublimation) of material in vacuum, according to some embodiments of the invention.

FIG. 5 is a high-level schematic illustration of possible implementations of forming the material for the irradiation target layer by evaporating and deposition of material in vacuum from a previously manufactured target of the same design, according to some embodiments of the invention.

FIG. 6 is a high-level schematic illustration of possible implementations of forming the material for the irradiation target layer by deposition from a liquid medium under the influence of an electric current, according to some embodiments of the invention.

FIG. 7 is a high-level schematic illustration of possible implementations of forming the material for the irradiation target layer by evaporating and deposition of material in vacuum from a pre-fabricated sample of volatile metal, according to some embodiments of the invention.

FIGS. 8 and 9 are high-level schematic cross-section illustrations of possible geometries of the back surface of the target base plate with grooves and pits, respectively, to contact the heat exchange medium, according to some embodiments of the invention.

FIG. 10 is a high-level schematic illustration of a possible implementation of the sublimation process from the irradiated target and collection of the volatile component onto the cold finger surface, which comprises the optional detachable crucible, according to some embodiments of the invention.

FIG. 11 is a high-level schematic illustration of a possible implementation of the sublimation process from the irradiated target and collection of the volatile component onto the cold trap internal surface, according to some embodiments of the invention.

FIG. 12 is a high-level schematic illustration of a possible implementation of the irradiation target, according to some embodiments of the invention.

FIG. 13 provides information regarding the yield dependencies of the radionuclide At-211 using disclosed targets, processes and systems, according to some embodiments of the invention.

FIG. 14 provides information regarding the yield dependencies of the radionuclide Lu-177 using disclosed targets, processes and systems, according to some embodiments of the invention.

FIG. 15 provides information regarding the yield dependencies of the radionuclide Tb-152 using disclosed targets, processes and systems, according to some embodiments of the invention.

FIG. 16 provides information regarding the yield dependencies of the radionuclide Cu-67 using disclosed targets, processes and systems, according to some embodiments of the invention.

FIG. 17 provides information regarding the yield dependencies of the radionuclide I-123 using disclosed targets, processes and systems, according to some embodiments of the invention.

FIG. 18 is a high-level schematic overview illustration of various components of the target, various properties of those components and various specific processes involved in their manufacturing, according to some embodiments of the invention.

FIG. 19 is a high-level schematic illustration of a possible implementation of processing of the material for irradiation with a laser, according to some embodiments of the invention.

FIG. 20 is a high-level flowchart illustrating a method of producing radionuclides, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present invention provide efficient and economical methods and mechanisms for producing radionuclides and thereby provide improvements to the technological field of nuclear engineering. Irradiation targets, systems and methods are provided for producing radionuclides by irradiation of the target with ions from a particle accelerator. Irradiation targets comprise a metallic layer enriched with a specific metal isotope, a base plate supporting the metallic layer, and an isolating layer covering the metallic layer on the base plate by at most 3 μm of a deposited metal having a low vapor pressure. The base plate is made of a metal or metal alloy that has a high thermal conductivity, and the irradiation target is configured to be set within a case of an irradiation device that irradiates the metallic layer thereof with the ions. Methods and systems of producing the irradiation targets and processing the targets after their irradiation are further provided.

Various embodiments include radionuclide production systems comprising: (i) a base plate, such as a plate of metal or metallic alloy with high thermal conductivity, having a dedicated generally flat area of frontal surface, which is exposed to the vacuum of an irradiation device (e.g., at a particle accelerator output) and another dedicated area of the base plate back surface, which is exposed to a flow of a heat transferring medium, provided and/or circulated by the irradiation device, (ii) a material for irradiation, such as a metallic layer of one of the listed materials: ytterbium, cadmium, zinc, bismuth (or its alloy), europium, tellurium, rubidium alloy, barium, antimony or arsenic, which is naturally contains or artificially enriched to contain at least 65% of a specific isotope of the metal, deposited over a part of the surface of the generally flat area of the base plate, (iii) an isolating layer, such as a thin layer of metal having low vapor pressure, deposited by means of physical vapor deposition technique over the material for irradiation so that no surface of the material for irradiation is exposed to external medium (e.g., atmosphere, vacuum or other). The thickness of the layer in the places where the material for irradiation is lied underneath is generally equal or less than 3 micrometers.

Various embodiments include methods of radionuclide production comprising: producing the target as disclosed herein, irradiation of the produced target with an ion beam from the particle accelerator which may include at least some of the following: ionized atoms of deuterium (hydrogen-2), ionized atoms of helium-3, ionized atoms of helium-4, ionized atoms of carbon-12, and processing the irradiated target in a plurality of steps to extract the radionuclides generated therein.

Various embodiments include systems and corresponding methods for a large-scale and therefore economical production of various radionuclides. Methods and systems are provided for production of radionuclides by means of nuclear reactions initiated by the irradiation with a beam of accelerated ions from a particle accelerator. Disclosed methods and systems address radionuclide production processes in which either an initial material (material for irradiation) or the product of irradiation are volatile substances, which are readily evaporated and/or sublimates when heated under reduced pressure (in vacuum). Disclosed embodiments include both the initial materials (material for irradiation) and the products of irradiation are volatile substances.

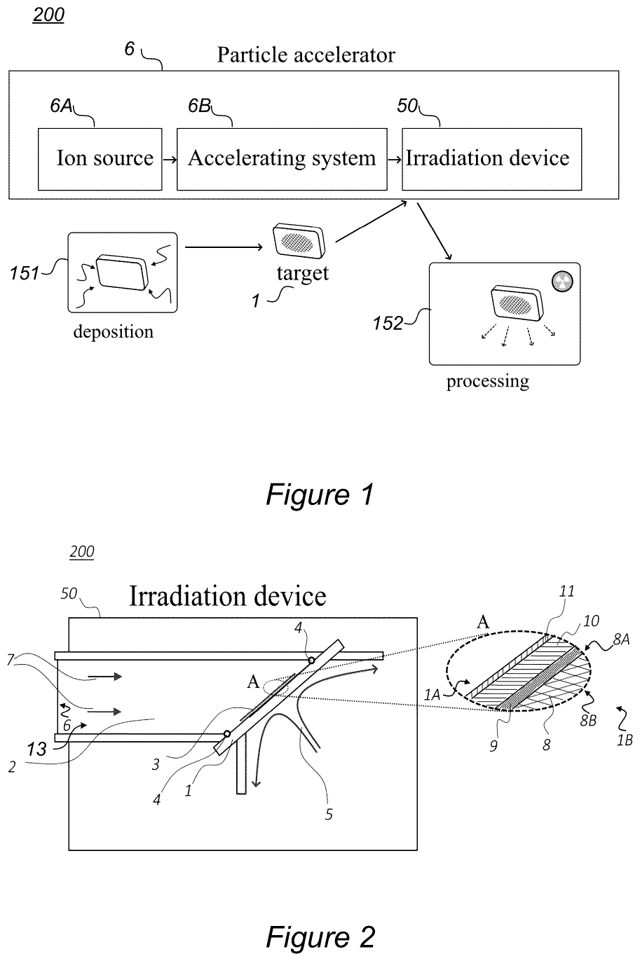

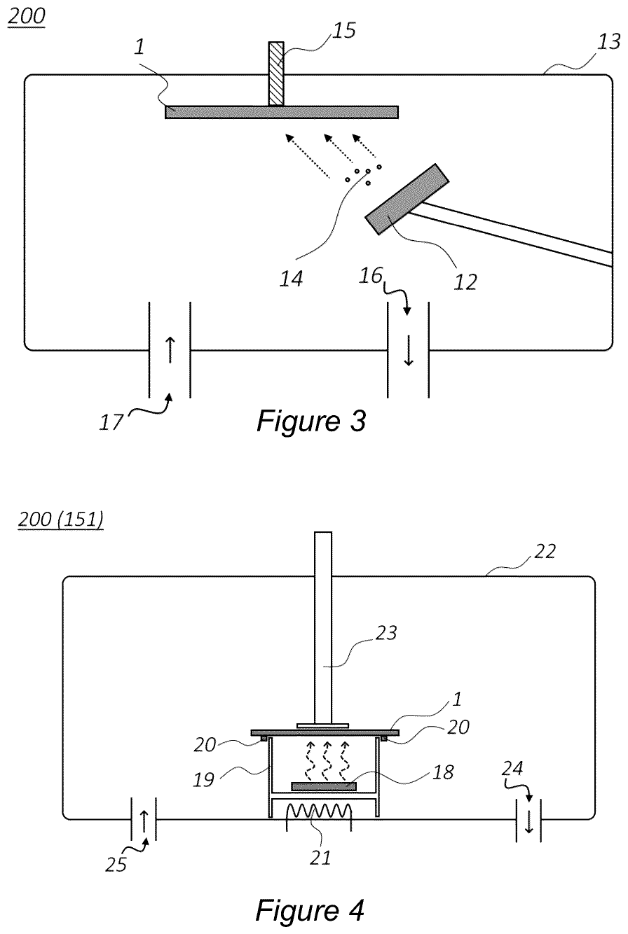

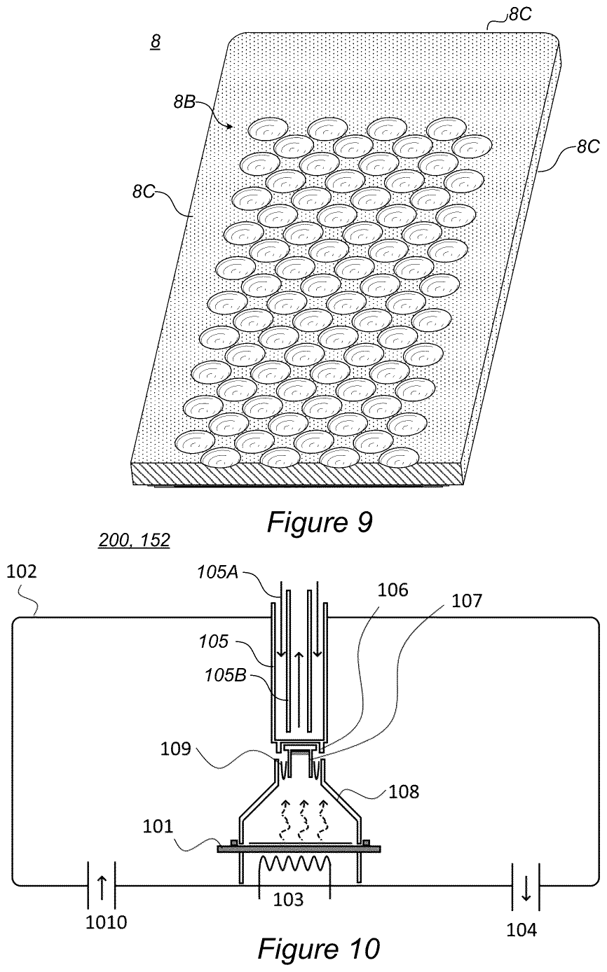

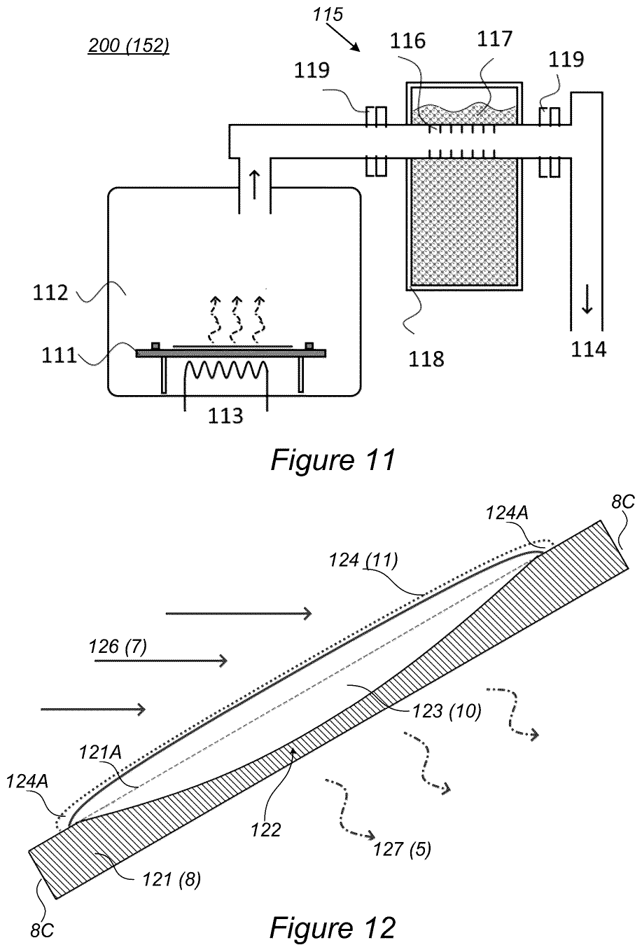

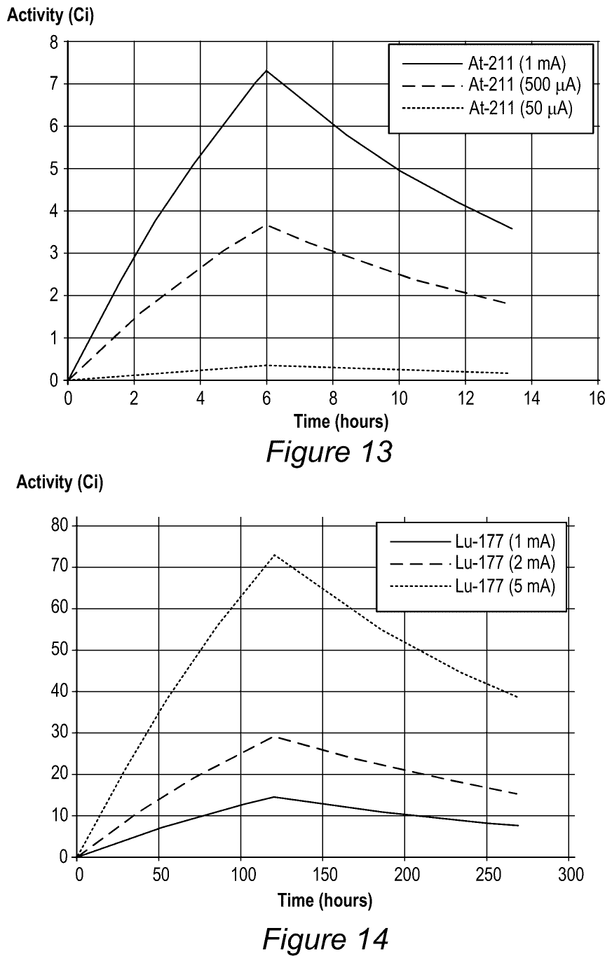

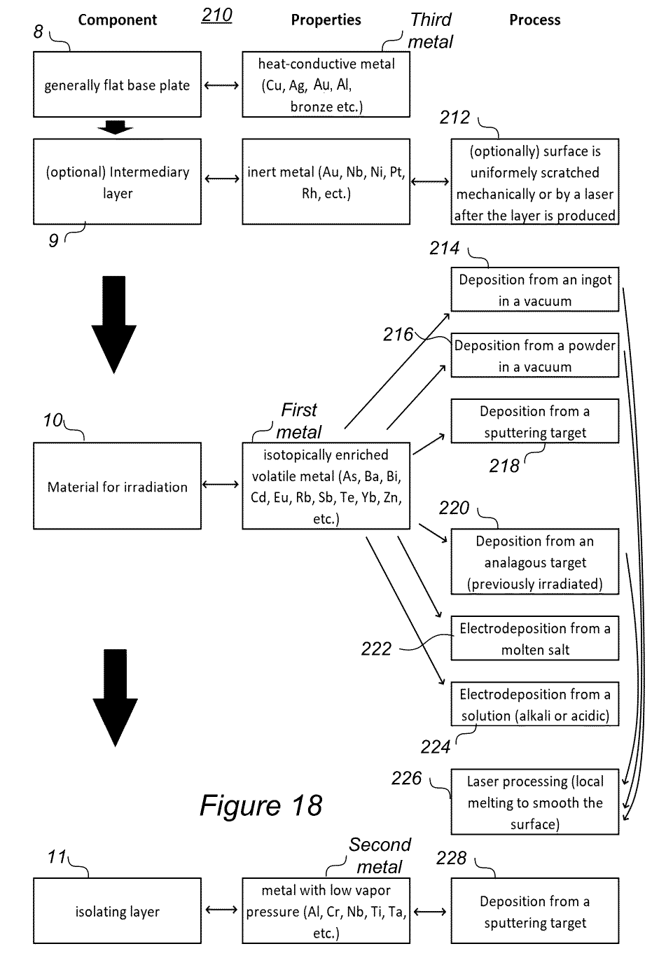

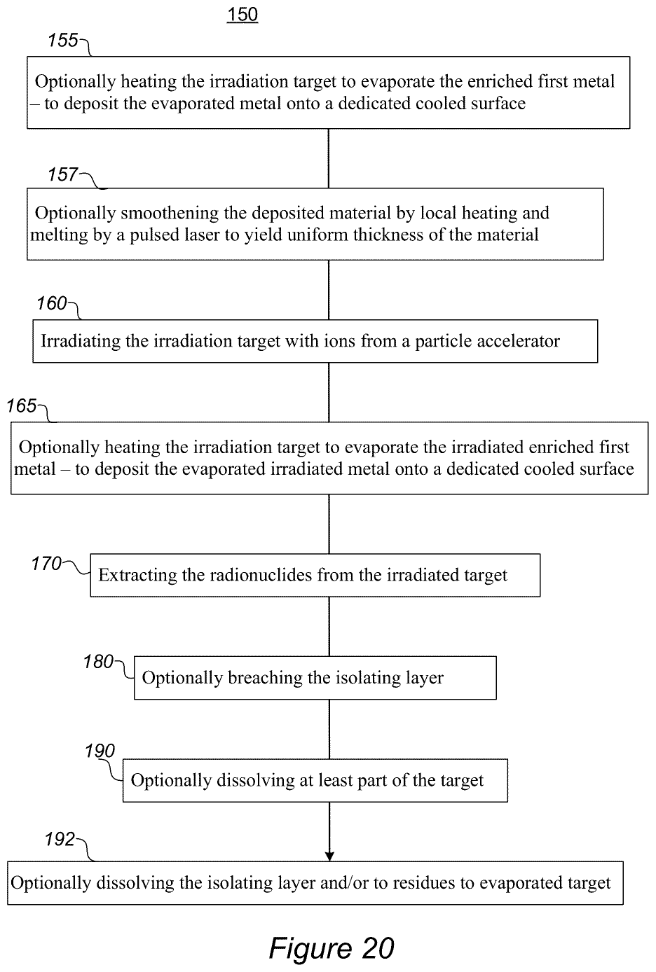

The following illustrations demonstrate non-limiting embodiments for disclosed targets 1, systems 200 and methods 150, and include detailed description of elements thereof. FIGS. 1 and 2 generally describe systems 200 and methods 150 for processing and irradiating targets 1, FIGS. 3-7 generally describe deposition processes 151 of metallic layer and optionally isolating layer 11, FIGS. 8 and 9 generally describe base plate 8 of target 1, FIGS. 10 and 11 generally processing 152 of irradiated targets, FIG. 12 generally describes configurations of irradiated target 1, FIGS. 13-17 provide non-limiting examples for yield dependencies of some radionuclides, FIG. 18 provides an overview of some of the disclosed components, materials and preparation processes, FIG. 19 provides examples for laser processing and FIG. 20 provides schematic method stages of producing radionuclides.

Various embodiments comprise an irradiation target 1 for producing a radionuclide by irradiation thereof with ions from a particle accelerator 6. Irradiation target 1 comprises a metallic layer 10 comprising a first metal enriched with a specific metal isotope, a base plate 8 supporting the metallic layer, and an isolating layer 11 covering metallic layer 10 on base plate 8 by at most 3 μm of a deposited second metal that has a vapor pressure below 1 Pa at 1200 °C Base plate 8 has a front surface (8A) that supports metallic layer 100 and a back surface (8B), and is made of a third metal or metal alloy that has a thermal conductivity above 150 W/(m·K). Irradiation target 1 may be configured to be set within a case of an irradiation device 50 that irradiates metallic layer 10 thereof with the ions, as disclosed herein.

Various embodiments include systems 200 of producing radionuclides, which comprise an irradiation device 50 comprising a vacuum chamber (e.g., 13, 102, 112, etc.) enclosing 1 irradiation target 1 and a particle accelerator 6 providing ions 7 into irradiation device 50 for irradiating target 1. It is noted that the terms “radionuclide” and “radionuclides” are used interchangeably in a non-limiting manner.

The following illustrations further demonstrate various non-limiting embodiments of depositing target 1 (stage 151) and of processing irradiated target 1 (stage 152), as illustrated schematically in FIG. 1. For example, system 200 may further comprise a heating element (e.g., 103, 113, etc.) configured to heat irradiation target 1 to evaporate at least a part of the first metal enriched with a specific metal isotope before or after irradiation, and a dedicated cooled surface (e.g., 106) within irradiation device 50, as illustrated in the following. For example, systems 200 may be configured to deposit at least 60% of the evaporated metal or the evaporated irradiated metal onto the dedicated cooled surface. The heating element may be configured to heat irradiation target 1 to temperatures between 300 °C-500 °C, 500 °C-700 °C or 700 °C-1000 °C or any intermediate values.

FIG. 1 is a high-level schematic block diagram of using an irradiation target 1, according to some embodiments of the invention, and illustrates the operational cycle of target 1 for radionuclide production. Target 1 may be produced by deposition of various materials on a base plate. Various deposition processes are illustrated in more detail in FIGS. 3 to 7. The produced target 1 is placed inside an irradiation device 50 (also termed target station) of a particle accelerator 6 (for example, a linear ion accelerator). After the irradiation of the target with a specific type of accelerated ions (e.g., deuterons, alpha particles, helion particles (nuclei of a helium-3 atom), etc.) for some time which is determined by the amount of radionuclide activity needed to be manufactured, target 1 is extracted from irradiation device 50 and placed into a compartment with radiation shielding (also termed hot cell) and processed there for extraction of the produced radionuclide.

Particle accelerator 6 comprises an accelerating system 6B, e.g., a linear or a circular accelerator, associated with an ion source 6A, and is configured to accelerate and provide ionized atoms 7 such as deuterium (hydrogen-2), helium-3, helium-4 and carbon-12 to irradiation device 50. Particle accelerator 6 may be configured to provide a beam current equivalent to at least 100, 250, 500 or 1500 microamperes in electrical current with accelerated ions 7 having a kinetic energy of at least 4 MeV per nucleon.

FIG. 2 is a high-level schematic illustration of using the target to produce radionuclides, according to some embodiments of the invention, and illustrates the principle of operation of target 1 inside irradiation device 50 and the internal structure of target 1 according to some embodiments of the invention. Target 1 is placed inside irradiation device 50, with a front surface 1A of target 1 with deposited materials 3 facing vacuum of internal volume 2 of irradiation device 50. In some embodiments vacuum seals 4 made of, e.g., vacuum rubber, fluoropolymers or a malleable metal are installed to protect vacuum from leaks of cooling medium or external air. A back side 1B of target 1 is exposed to a heat transfer medium 5 which may be maintained in closed loop circulation and removes excessive heat from target 1 (FIGS. 8 and 9 illustrate schematically possible geometries of back surface 8B of target base plate 8 with grooves and pits, respectively, to contact heat exchange medium 5). From the vacuum of accelerator 6, an accelerated ion beam 7 is delivered onto target 1, e.g., at an acute angle between the centerline of the beam and the plane of the target frontal surface. Heat transfer medium 5 may be associated with one or more heating element(s) to provide the required temperature.

The cross-section ‘A’ illustrates the internal structure of target 1, according to some embodiments of the invention. Irradiation target 1 may comprise a base plate 8 made of heat-conductive metal or alloy (e.g., copper, aluminum, silver, gold or alloys of those metals in any combination). In some embodiments, irradiation target 1 may comprise an intermediary layer 9 of inert metal (e.g., gold, platinum, rhodium, nickel or niobium). Irradiation target 1 may comprise a material 10 for irradiation, e.g., a metallic layer including a first metal enriched with a specific metal isotope, which may be a volatile metal or alloy (e.g., ytterbium, cadmium, zinc, bismuth (or its alloy), europium, tellurium, rubidium(alloy), barium, arsenic or antimony) that contains a high portion of the specific isotope of the metal, which may be enriched naturally or by means of isotopic enrichment. The high portion of the specific isotope is dependent on the specific chemical element and on the level of practiced enrichment, and may range between 10% to over 99% enrichment depending on the available material for irradiation and requirements for radionuclides to be produced. Irradiation target 1 may comprise an isolating layer 11 made from a second metal with low vapor pressure (e.g., titanium, aluminum, chromium, niobium or tantalum).

In some embodiments, at least a portion of front surface 8A of base plate 8, which supports metallic layer 10—may be flat. In some embodiments, front surface 8A of base plate 8 may comprise a pit having a curvature radius of at least 100 mm and a maximal depth of at most 0.5 mm, as illustrated and described in further details in FIG. 12.

In various embodiments, the first metal of which metallic layer 10 is made of, may comprise one of: ytterbium, cadmium, zinc, bismuth or an alloy thereof, europium, tellurium, rubidium alloy, barium, antimony or arsenic. The first metal may comprise at least 10 wt % of the enriched specific metal isotope, as provided in multiple examples herein. Metallic layer 10 may be deposited by evaporation of heated source material in vacuum, by physical vapor deposition of atoms provided by magnetron sputtering or by other methods, as disclosed in further details below.

In various embodiments, the third metal or alloy thereof, of which base plate 8 is made of, may comprise at least one of: copper, silver, aluminum, gold or alloys thereof having over 84% by mass.

In various embodiments, isolating layer 11 may be made of the second metal comprises one of: titanium, aluminum, chromium, niobium, tantalum, and may be deposited by physical vapor deposition of atoms provided by magnetron sputtering. Isolating layer 11 may have a thickness above most of metallic layer 10 that is between 0.1 μm and 1 μm, between 1 μm and 2.5 μm, or between 2.5 μm and 4μm. In some embodiments, isolating layer 11 may have a thickness at edges of metallic layer 10 that is 2 to 20 times greater than a thickness thereof above metallic layer 10 (see also FIG. 12).

In some embodiments, target 1 may further comprise intermediary layer 9 between front surface 8A of base plate 8 and metallic layer 10. Intermediary layer 9 may comprise an inert metal, such as gold, platinum, rhodium, nickel and niobium or combinations thereof. Intermediary layer 9 may be under 300 μm thick, and may cover over half of front surface 8A.

In various examples, intermediary layer 9 may be configured to have a thickness between 5 μm and 20 μm. In various examples, intermediary layer 9 may be configured to have a thickness between 20 μm and 50 μm and specifically altered surface roughness that are up to 10 μm Rₘₐₓ prior to deposition of metallic layer 10 thereupon. In various examples, intermediary layer 9 may be configured to have a thickness between 50 μm and 100 μm and surface roughness that are up to 20 μm Rₘₐₓ prior to deposition of metallic layer 10 thereupon. In various examples, intermediary layer 9 may be configured to have a thickness between 100 μm and 300 μm and surface roughness that are up to 40 μm Rₘₐₓ prior to deposition of metallic layer 10 thereupon. It is noted that Rₘₐₓ denotes the maximum roughness depth, or maximum height difference, such as the largest single peak-to-valley height within a measured length.

FIG. 3 is a high-level schematic illustration of possible implementations of the process of forming or depositing isolating layer 11, according to some embodiments of the invention. In the illustration, material for isolating layer 11 that coats target 1 may be deposited by sputtering (evaporation through bombardment by particles from plasma of some type of discharge, maintained by DC or RF current) of a sputtering target 12 (optionally more than one) inside vacuum chamber 13 so material released (14) from the sputtering target 12 bombards and covers the surface of target 1 (e.g., placed on a movable holder 15) and forms isolation layer 11. Vacuum chamber 13 may have an output to a vacuum pump 16 and an input for low pressure inert gas (e.g., argon) 17. In some embodiments covering of some parts of the target surface by mask, collimator or other screening object prevents deposition of the material in corners, over gaps for vacuum seals and/or in other undesired locations on target 1. Sputtering target 12 may comprise various materials as the second metal disclosed herein, e.g., titanium, aluminum, chromium, niobium, tantalum, deposited to produce isolating layer 11 that covers the material for irradiation (enriched first metal of target 1) with a thin film, generally 3 micrometer or less in thickness, over the whole target or possibly with exception of edges of the deposition area where the layer might be thicker to ensure complete insulation of the surface of the target material for irradiation.

FIG. 4 is a high-level schematic illustration of possible implementations of forming the material for irradiation target layer 10 by evaporation and deposition 151 (e.g., sublimation) of material in vacuum, according to some embodiments of the invention. For example, deposition (stage 151) of the material for irradiation onto target 1 may be implemented by means of evaporation of a solid ingot of a volatile metal 18. Target 1 may be positioned on a target holder 19 with dedicated protrusions 20 (which in some embodiments may be replaced with grooves or holes). Target holder 19 may be placed inside a vacuum chamber 22 and equipped with an electrically powered heater 21. Target 1 may be held in place by, e.g., a movable holder 23 that may include a cooling channel for maintaining the temperature of the target during the process. Vacuum chamber 22 may have an output to a vacuum pump 24 and an input for the inert gas (e.g., argon) 25 to avoid oxidation of ingot 18 during the assembling. In some embodiments instead of ingot 18 a powder or mixture of powders may be used. In some embodiments, a mixture of powders may undergo chemical reaction(s) that release the volatile elemental material to be deposited. In some embodiments, ingot 18 may be melted during the process.

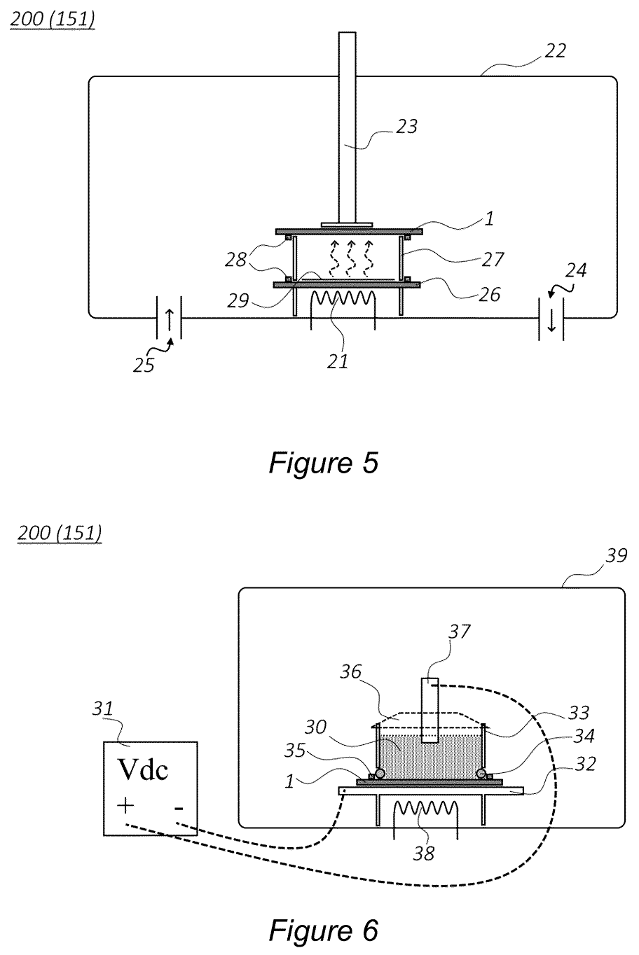

FIG. 5 is a high-level schematic illustration of possible implementations of forming the material for irradiation target 1 by evaporating and deposition (151) of material in vacuum from a previously manufactured target of the same design, according to some embodiments of the invention. Accordingly. In some embodiments, the source material for irradiation target 1 may comprise a previously used irradiation target having an impaired isolating layer. FIG. 5 illustrates schematically a variant of FIG. 4, in which an earlier manufactured target 26 is used as a source of volatile material for deposition onto target 1, instead of ingot 18. In some embodiments, the impairment of the isolating layer of the earlier manufactured target may be carried out by puncturing, scratching or cutting, to allow evaporation of the volatile material underneath the isolating layer. Such impairment may be carried out mechanically with a sharp instrument that has a working surface or edge made of hard inert material such as hardened steel, tungsten, molybdenum, tantalum, quartz, ceramics (e.g., tungsten carbide, aluminum oxide, titanium nitride) etc. In some embodiments, puncturing of the isolating layer may be conducted in the form of individual punctures or cuts, or an intersecting grid of cuts, produced using a laser. An enclosed sheet of metal 27 and protrusions or grooves 28 may be used to ensure the correct relative positioning of target 1 and earlier manufactured target 26. In some embodiments, earlier manufactured target 26 may be used in the process shortly after being irradiated, so that when the volatile material for the next irradiation is separated, a non-volatile residue 29 contains a significant portion (e.g., over 65%) of the radionuclide produced during irradiation.

In some embodiments, such separation methods may be practiced, in non-limiting examples, for extraction of lutetium radionuclides from an ytterbium target material, for extraction of terbium radionuclides from an europium target material, for extraction of copper radionuclides from a zinc target material, for extraction of tin radionuclides from a cadmium target material, for extraction of yttrium radionuclides from a rubidium alloy target material, for extraction of cerium radionuclides from a barium target material and so forth. In some embodiments, additional heaters and/or cooling elements (not shown) may be introduced from the outer surface of enclosed sheet of metal 27 to increase the speed and the yield and/or efficiency of deposition process 151—e.g., to increase the portion of the deposited material in relation to the material used in the process.

In some embodiments, the material for irradiation on target 1 may be further processed after deposition 151 and before the formation of isolating layer 11 on top ot target 1, e.g., using a pulsed laser. Further processing may be conducted in an inert atmosphere (e.g., argon or helium) at atmospheric or higher pressure (in some embodiments up to 10 bar) and comprise locally heating the deposited layer on target 1 by laser pulses to reach the melting point of the material for irradiation, yielding local melting and resulting smoothening of the surface and reaching a unified thickness of deposited metallic layer 10.

FIG. 6 is a high-level schematic illustration of possible implementations of forming the material for irradiation target layer 10 by deposition (151) from a liquid medium under the influence of an electric current, according to some embodiments of the invention. The source material for metallic layer 10 may thus comprise a liquid medium and deposition (151) may be carried out by means of electroplating (electrochemical deposition) applying an electric current thereto. The liquid medium may comprise a solution or molten salt 30 under the effect of DC electric current provided by a power supply 31. Target 1 may be placed in an electric contact onto a stand 32 having a conductive, e.g., metallic top surface, connected to the negative terminal of power source 31. An enclosed sheet of chemically inert non-conductive material (e.g., quartz glass) 33 may be placed over front surface 1A of target 1 with a leak-proof seal 34 positioned with protrusions 35 (or in some embodiments grooves) on the surface of target 1. Non-conductive holder 36 may be configured to hold enclosed sheet 33 and an anode 37 made from inert conductive material (in some embodiment platinum or graphite) over target 1. In some embodiments, electric heater 38 may be used to maintain optimal conditions for deposition 151. The whole process may be conducted inside a fume hood or an isolating glove box 39. In some embodiments, inert gas (e.g., argon) may be used to fill glove box 39.

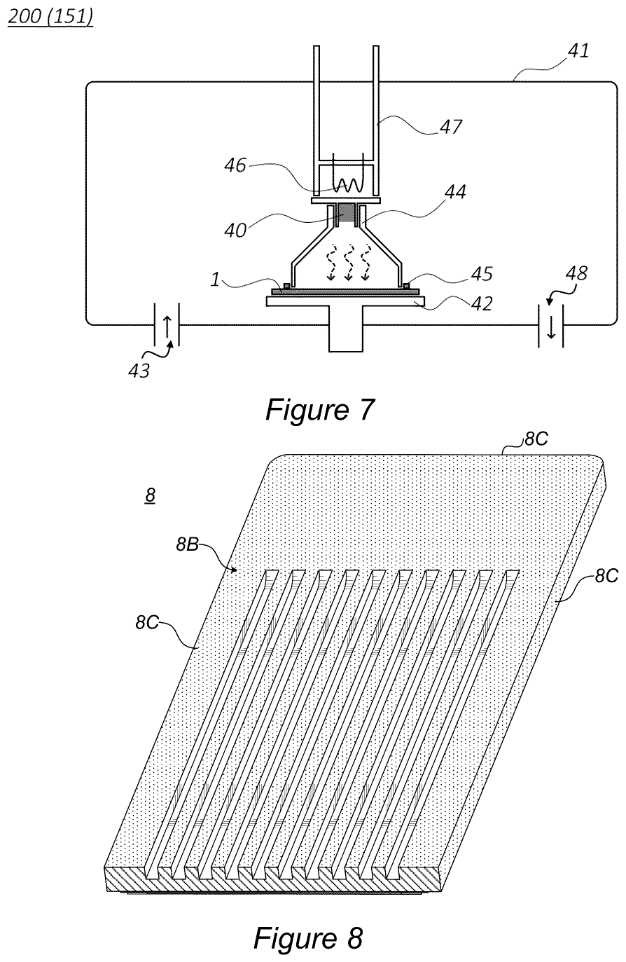

FIG. 7 is a high-level schematic illustration of possible implementations of forming the material for irradiation target layer 10 by evaporating and deposition (151) of material in vacuum from a pre-fabricated sample of volatile metal 40, according to some embodiments of the invention. The source material for metallic layer 10 may thus comprise pre-fabricated sample, ingot or powder of volatile metal 40, e.g., having vapor pressure of 1 Pascal or higher at 800 °C FIG. 7 illustrates a variant of the process illustrated in FIG. 4, in which instead of ingot 18—an ampoule/crucible with a pre-fabricated volatile material 40 may be used to deposit the material for irradiation as metallic layer 10 onto target 1. The target may be placed inside a vacuum chamber 41 onto a target holder 42, e.g., equipped with forced air or water cooling. Then vacuum chamber 41 may be filled with inert gas (e.g., argon) via a gas input 43. Consecutively, ampoule holder 44 and ampoule/crucible 40 may be introduced into the inert atmosphere. Ampoule holder 44 may comprise a conical sheet of inert metal (e.g., niobium) with the bottom corresponding to the deposition area on frontal surface 1A of target 1 and the top corresponding to the dimensions of ampoule/crucible 40 holding the volatile material. Ampoule holder 44 may be held between target 1 (e.g., positioned by protrusions or groves 45 of on the surface of target 1), and an electric heater 46 installed on a movable heater holder 47. After positioning all elements, the vacuum in vacuum chamber 41 may be created by pumping out gas by vacuum pump 48. After reaching the working vacuum, e.g., between 10⁻⁶ Pa and 10 Pa, electric heater 46 may be turned on and the process of evaporation and deposition (sublimation) 151 of volatile material to form metallic layer 10 may be conducted.

FIGS. 8 and 9 are high-level schematic cross-section illustrations of possible geometries of back surface 8B of target base plate 8 with grooves and pits, respectively, to contact heat exchange medium 5, according to some embodiments of the invention. Base plate 8 maybe be processed as target 1 disclosed herein, to deposit metallic layer 10 thereupon to form target 1.

In some embodiments, back surface 8B of base plate 8 may comprise grooves and/or pits configured to guide the flow of heat-transfer medium 5 in contact thereof. In non-limiting examples, back surface 8B of base plate 8 may comprise grooves (illustrated schematically in FIG. 8) that are between 1 mm and 4 mm in depth, and between 1 mm and 4 mm in width. In non-limiting examples, back surface 8B of base plate 8 may comprise semi-spherical pits (illustrated schematically in FIG. 9) that are between 0.5 mm and 2 mm in depth, and between 2 mm and 10 mm in diameter. In non-limiting examples, a minimal thickness of base plate 8 may be between 0.5 mm and 2 mm, between 2 mm and 4 mm, or between 4 mm and 8 mm, or have intermediate values.

In various embodiments, base plate 8 may be configured to maintain vacuum sealing and leak-proof sealing at contact regions thereof (e.g., edges 8C) with the case of irradiation device 50 and/or vacuum chamber(s) (e.g., 13, 22, 39, 41, 102, 112, etc.) in which it is places, e.g., for deposition (151) and processing (152) as disclosed herein.

In some embodiments, base plate 8 may be configured to have protrusions and/or grooves (e.g., 20, 28, 35, 45 etc.) at or close to edges 8C configured to accurately position base plate 8 during deposition of metallic layer 10 thereupon by evaporation of heated source material in vacuum to form target 1 and to prevent material losses during deposition 151.

Following the irradiation of target 1, it may be heated to evaporate at least a part of the first metal enriched with a specific metal isotope—onto dedicated cooled surface 106 within irradiation device 50—as part of processing stage 152.

FIG. 10 is a high-level schematic illustration of a possible implementation of the sublimation process (152) from irradiated target 1, and collection of the volatile component onto a cold finger surface 105, which comprises an optional detachable crucible, according to some embodiments of the invention.

For processing 152, isolation layer 11 may be removed or breached off irradiated metallic layer 10 of target 1, and irradiated target (denoted by numeral 101) may be placed into a vacuum chamber 102 and heated by a heating element 103 under reduced pressure (e.g., vacuum) produced via pumping out gas by a vacuum pump connected to a tubing 104.

In some embodiments, cold finger 105 may comprise a metallic tube having a closed end (e.g., as cooled surface 106) inside vacuum chamber 102 and an internal membrane 105B that separates an internal volume of the metallic tube into two parallel or coaxial tubes that are interconnected near the close end of the tube—to allow circulation of heat exchange medium 105A to cool the closed end. The metallic tube may further comprise a detachable collection vessel 107 such as a crucible made of inert metal or alloy to collect deposited evaporated material.

Cold finger 105 with circulating heat exchange medium 105A (e.g., water, compressed air, argon, industrial coolant liquid) may be positioned so that a cooled surface 106 thereof, optionally with an attachable collecting crucible 107 on it, is in fluid communication with the generally flat surface of irradiated target 101. An optional alignment device 108 may be configured to form a cupola, or a small dome, over irradiated target 101 that may be used to reduce losses of sublimed material. Further loss reduction may be implemented by using a metallic seal 109 between alignment device 108 and collecting crucible 107. To avoid oxidation or other chemical effects on irradiated target 101 (having breached isolating layer 11), chamber 102 may be filled with an inert gas prior provided via a gas input 1010. Crucible 107 may provide

FIG. 11 is a high-level schematic illustration of a possible implementation of the sublimation process (152) from irradiated target 111 and collection of the volatile component onto the cold trap internal surface, according to some embodiments of the invention. For processing 152, isolation layer 11 may be removed or breached off irradiated metallic layer 10 of target 1, and irradiated target (denoted by numeral 111) may be placed into a vacuum chamber 112 and heated by a heating element 113 under reduced pressure (e.g., vacuum) produced via pumping out gas by a vacuum pump connected to a tubing 114.

In some embodiments, the dedicated cooled surface may comprise a cold trap 115 provided within the vacuum chamber or in fluid communication therewith, and having externally cooled walls. For example, cold trap 115 may have cold surfaces 116 that may be cooled, e.g., by evaporation of liquid nitrogen 117 from heat-insulating tank 118. Optional fast connectors 119 or equivalents thereof may be used to allow fast disconnection of trap 115 from vacuum chamber 112 and enable extraction of the volatile component deposited therein. Such processing configuration may be used when the generated radionuclides are a volatile substance such as, in non-limiting example, bromine, iodine or astatine.

In some embodiments, the dedicated cooled surface may comprise a cold metallic layer comprising the first metal (as in target 1).

FIG. 12 is a high-level schematic illustration of a possible implementation of irradiation target 1 (partial and not to scale), according to some embodiments of the invention. While in some embodiments target 1 and base plate 8 may be flat (illustrated schematically by the dashed line 121A indicating the level of the base plate flat surface), in other embodiments, the generally flat area of base plate 121 (base pate 8) may comprise a pit 122 having a low curvature (e.g., at least 100 mm curvature radius and depth of 0.5 mm or less) over which material for irradiation 123 (metallic layer 10) may be deposited and subsequently covered with isolating layer 124 (isolating layer 11). Thin isolating layer 124 may be deposited in a way that yields significantly thicker edges 124A compared to the central part of the isolating layer above the pit. The direction of ion beam 126 (providing ions 7) and of the heat removal by transferring medium 127 (medium 5) are indicated for the general understanding of the system configuration.

As disclosed, edges 8C of base plate 8 may be configured to maintain vacuum sealing and leak-proof sealing at contact regions thereof with the case of irradiation device 50 and/or vacuum chamber(s) (e.g., 13, 22, 39, 41, 102, 112, etc.) in which it is places, e.g., for deposition (151) and processing (152) as disclosed herein; as well as protrusions and/or grooves (e.g., 20, 28, 35, 45 etc.) configured to accurately position base plate 8 during deposition of metallic layer 10 an isolating layer 11 thereupon by evaporation of heated source material in vacuum to form target 1 and to prevent material losses during deposition 151.

In various embodiments, the first metal of irradiated metallic layer 10 may comprise metallic ytterbium enriched with at least 10% ytterbium-176, irradiated ions 7 may comprise ionized atoms of deuterium and the produced radionuclides may comprise lutetium-177.

In various embodiments, the first metal of irradiated metallic layer 10 may comprise metallic cadmium enriched with at least 75% cadmium-116, irradiated ions 7 may comprise ionized atoms of helium and the produced radionuclides may comprise tin-117m.

In various embodiments, the first metal of irradiated metallic layer 10 may comprise metallic cadmium enriched with at least 65% zinc-70, irradiated ions 7 may comprise ionized atoms of deuterium and the produced radionuclides may comprise copper-67.

In various embodiments, the first metal of irradiated metallic layer 10 may comprise metallic bismuth or an alloy containing over 90% of bismuth by mass, enriched with at least 99% bismuth-209, irradiated ions 7 may comprise ionized atoms of helium-4 and the produced radionuclides may comprise astatine-211.

In various embodiments, the first metal of irradiated metallic layer 10 may comprise metallic europium enriched with at least 45% europium-151, irradiated ions 7 may comprise ionized atoms of helium and the produced radionuclides may comprise terbium-149.

In various embodiments, the first metal of irradiated metallic layer 10 may comprise metallic europium enriched with at least 45% europium-151, irradiated ions 7 may comprise ionized atoms of helium and the produced radionuclides may comprise terbium-152.

In various embodiments, the first metal of irradiated metallic layer 10 may comprise metallic europium enriched with at least 45% europium-153, irradiated ions 7 may comprise ionized atoms of helium-4 and the produced radionuclides may comprise terbium-155.

In various embodiments, the first metal of irradiated metallic layer 10 may comprise metallic tellurium enriched with at least 90% tellurium-122, irradiated ions 7 may comprise ionized atoms of deuterium and the produced radionuclides may comprise iodine-123.

In various embodiments, the first metal of irradiated metallic layer 10 may comprise metallic tellurium enriched with at least 90% tellurium-124, irradiated ions 7 may comprise ionized atoms of deuterium and the produced radionuclides may comprise iodine-124.

In various embodiments, the first metal of irradiated metallic layer 10 may comprise metallic tellurium enriched with at least 90% tellurium-125, irradiated ions 7 may comprise ionized atoms of deuterium and the produced radionuclides may comprise iodine-125.

In various embodiments, the first metal of irradiated metallic layer 10 may comprise metallic tellurium enriched with at least 90% tellurium-130, irradiated ions 7 may comprise ionized atoms of deuterium and the produced radionuclides may comprise iodine-131.

In various embodiments, the first metal of irradiated metallic layer 10 may comprise rubidium alloy containing at least 75% by mass of rubidium and up to 25% by mass of indium, enriched with at least 90% rubidium-87, irradiated ions 7 may comprise ionized atoms of helium-4 and the produced radionuclides may comprise yttrium-90.

In various embodiments, the first metal of irradiated metallic layer 10 may comprise metallic barium enriched with at least 70% barium-134, irradiated ions 7 may comprise ionized atoms of helium and the produced radionuclides may comprise cerium-134.

In various embodiments, the first metal of irradiated metallic layer 10 may comprise metallic arsenic enriched with at least 99% arsenic-75, irradiated ions 7 may comprise ionized atoms of helium and the produced radionuclides may comprise bromine-77.

In various embodiments, the first metal of irradiated metallic layer 10 may comprise metallic antimony enriched with at least 55% antimony-121, irradiated ions 7 may comprise ionized atoms of helium and the produced radionuclides may comprise iodine-123.

In various embodiments, the first metal of irradiated metallic layer 10 may comprise metallic antimony enriched with at least 55% antimony-121, irradiated ions 7 may comprise ionized atoms of helium and the produced radionuclides may comprise iodine-124.

In various embodiments, the first metal of irradiated metallic layer 10 may comprise metallic antimony enriched with at least 40% antimony-123, irradiated ions 7 may comprise ionized atoms of helium and the produced radionuclides may comprise iodine-125.

In shorthand, methods 150, systems 200 and targets 1 may be configurated for carrying out any of the following nuclear reactions (d denotes a deuteron, p denotes a proton, a denotes an alpha particle (helium nucleus), n denotes a neutron, m denotes a nucleus in a metastable state (also sometimes referred to as a nuclear isomer) and β-denotes a beta minus emission): Yb-176 (d, p)→Yb-177 (β-)→Lu-177; Yb-176 (d, n) →Lu-177; Cd-116 (a,3n)→Sn-117m; Zn-70 (d, a+n)→Cu-67; Bi-209 (a,2n)→At-211; Eu-151 (a,6n)→Tb-149; Eu-151 (a,3n)→Tb-152; Eu-153 (a,2n)→Tb-155; Te-122 (d, n)→I-123; Te-124 (d,2n)→I-124; Te-125 (d,2n)→I-125; Te-130 (d, n)→I-131; Rb-87 (a, n)→Y-90; Ba-134 (a,4n)→Ce-134; As-75 (a,2n)→Br-77; Sb-121 (a,2n)→I-123; Sb-121 (a, n)→I-124; and Sb-123 (a,2n)→I-125.

FIGS. 13-17 provide information regarding the yield dependencies of various radionuclides using disclosed targets, processes and systems, as non-limiting examples. The graphs provide the radionuclide activity A in Ci (Curie) units as a function of the time in hours for respective radionuclides in respective targets 1 during and shortly after irradiation, in correspondence with different irradiation intensities by beams of respective ions 7, indicated by respective current values.

FIG. 13 provides information regarding the yield dependencies of the radionuclide At-211 using disclosed targets 1, processes 150, 151, 152 and systems 200, according to some embodiments of the invention. Illustrated are the dependencies of radionuclide activity (yield) for Astatine-211 in the target during and shortly after irradiation, in correspondence with various intensities of the beam of accelerated helium ions. The material for irradiation was natural bismuth. An irradiation time of 6 hours is given as a non-limiting example.

FIG. 14 provides information regarding the yield dependencies of the radionuclide Lu-177 using disclosed targets 1, processes 150, 151, 152 and systems 200, according to some embodiments of the invention. Illustrated are the dependencies of radionuclide activity (yield) for Lutetium-177 in the target during and shortly after irradiation, in correspondence with various intensities of the beam of accelerated deuterons. The material for irradiation was ytterbium highly enriched with ytterbium-176 isotope. An irradiation time of 120 hours is given as a non-limiting example.

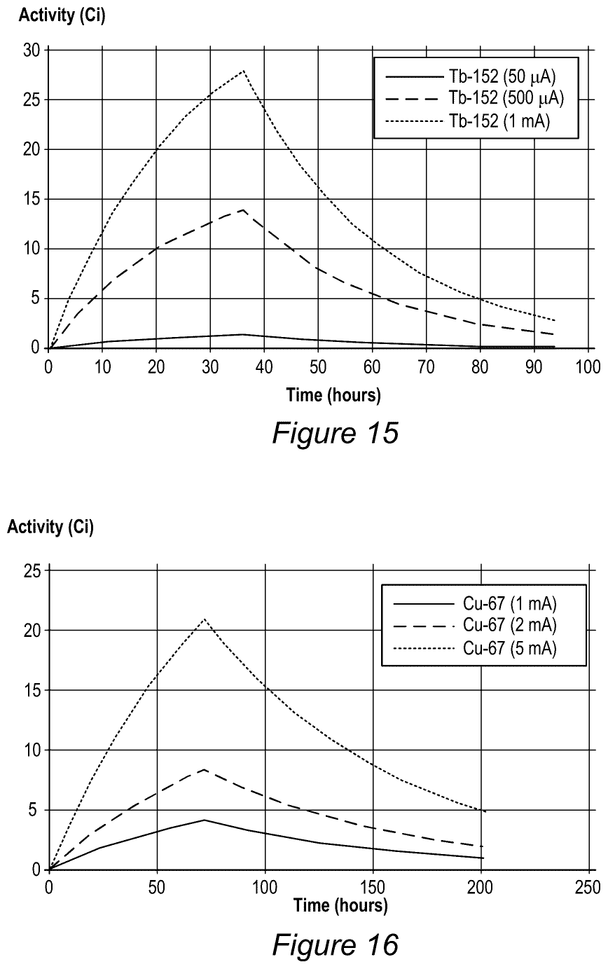

FIG. 15 provides information regarding the yield dependencies of the radionuclide Tb-152 using disclosed targets 1, processes 150, 151, 152 and systems 200, according to some embodiments of the invention. Illustrated are dependencies of radionuclide activity (yield) for Terbium-152 in the target during and shortly after irradiation, in correspondence with various intensities of the beam of accelerated helium ions. The material for irradiation was europium highly enriched with Europium-151 isotope. An irradiation time of 36 hours is given as a non-limiting example.

FIG. 16 provides information regarding the yield dependencies of the radionuclide Cu-67 using disclosed targets 1, processes 150, 151, 152 and systems 200, according to some embodiments of the invention. Illustrated are dependencies of radionuclide activity (yield) for Copper-67 in the target during and shortly after irradiation, in correspondence with various intensities of the beam of accelerated deuterons. The material for irradiation was zinc highly enriched with Zinc-70 isotope. An irradiation time of 72 hours is given as a non-limiting example.

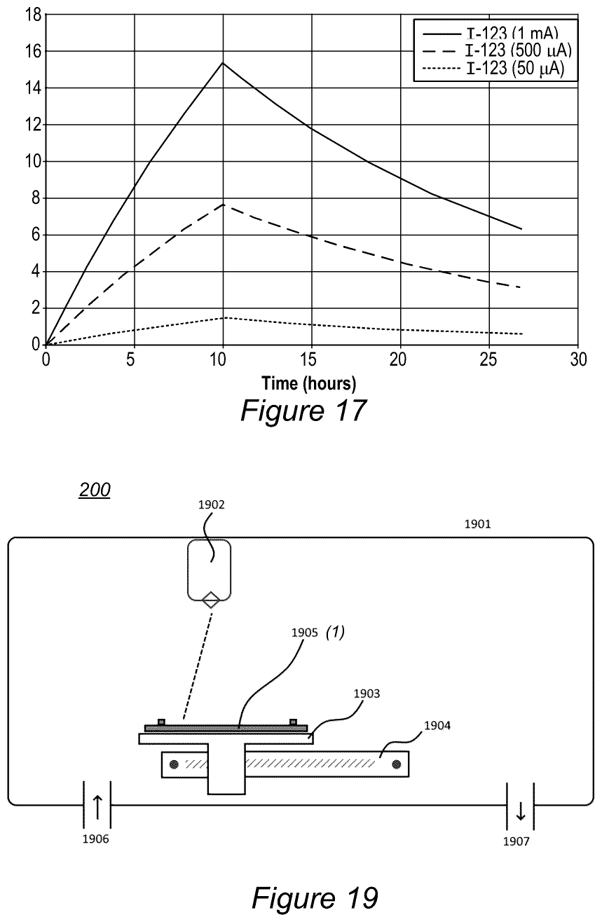

FIG. 17 provides information regarding the yield dependencies of the radionuclide I-123 using disclosed targets 1, processes 150, 151, 152 and systems 200, according to some embodiments of the invention. Illustrated are dependencies of radionuclide activity (yield) for Iodine-123 in the target during and shortly after irradiation, in correspondence with various intensities of the beam of accelerated deuterons. The material for irradiation was antimony highly enriched with Sb-121 isotope. An irradiation time of 10 hours is given as a non-limiting example.

FIG. 18 is a high-level schematic overview illustration 210 of various components of target 1, various properties of those components and various specific processes involved in their manufacturing, according to some embodiments of the invention. FIG. 18 provides a schematic overview of options 210 for implementations, and any applicable combination of these options is considered a non-limiting embodiment of the invention.

Specifically, FIG. 18 lists flat or pitted base plate 8 made of the third heat-conductive metal which may comprise copper, silver, aluminum, gold, bronze or alloys and combinations thereof; metallic layer 10 for irradiation made of the first metal enriched with a specific metal isotope; isolating layer 11 made of the second metal having low vapor pressure (e.g., titanium, aluminum, chromium, niobium, tantalum, etc.); and optionally intermediary layer 9 made of inert metal (e.g., gold, platinum, rhodium, nickel or niobium).

Various processes illustrated schematically in FIG. 18 and explained in detail herein include various deposition methods of metallic layer 10, including deposition from an ingot in vacuum 214 (see, e.g., FIG. 4), deposition from a powder in vacuum 216 (see, e.g., an alternative option in FIG. 4), deposition from a sputtering target 218 (analogous e.g., to FIG. 3), deposition from an analogous target, such as a previously irradiated target 220 (see, e.g., FIG. 5), electrodeposition from molten salt 222 (see, e.g., FIG. 6) and electrodeposition from an alkali or acidic solution 224 (see, e.g., FIG. 6)—as non-limiting examples for deposition processes 151, as well as the optional consecutive laser processing the deposited metallic layer to smoothen its surface by local melting 226 (see, e.g., FIG. 19). FIG. 18 further demonstrates schematically the processes of depositing isolating layer from a sputtering target (see, e.g., FIG. 3), and of processing the intermediary layer 9 to reach a required degree of roughness (212), e.g., by uniformly mechanically scratching or laser treating its surface (see, e.g., FIG. 19). FIG. 18 illustrates the structure of target 10 in a conceptual way, with description of elements and their properties, as well as key processes involved in its manufacturing. The manufacturing of base plate 8 (not shown) may be carried out using various methods of mechanical processing, including, in non-limiting examples, casting, cutting, milling, polishing with an abrasive, chemical etching, thermal annealing, etc.

FIG. 19 is a high-level schematic illustration of processing of the material for irradiation with a laser, according to some embodiments of the invention. FIG. 19 illustrates a possible embodiment, in systems 200, of using laser irradiation for smoothing the surface of material for irradiation (metallic layer 10) before isolating layer 11 is deposited over it. Systems 200 may comprise an isolating chamber 1901 with a laser system 1902, which may comprise an actual laser assembly of a solid state laser or an fiber-optic output of a laser system outside of the chamber, and processing plate 1903, which may be mechanically adjustable, e.g., using a dedicated screw or other mechanical actuator 1904 in two or more axis. The target (1) to be processed 1905 may be fixated on processing plate 1903. Inert gas (e.g., argon or helium) may be supplied through a gas input 1906 to avoid oxidation of the material for irradiation while atmospheric gases may be removed by a pump via a pump connection 1907.

In various embodiments, disclosed systems 200 may apply laser radiation for smoothening the surface of deposited metallic layer 10 and/or for breaching isolating layer 11 and/or altering surface roughness of intermediary layer 9.

When the process is applied to process the material for irradiation (metallic layer 10), laser 1902 may be powered in pulse mode to heat the surface of the material for irradiation (metallic layer 10) locally to the melting point of the material. Subsequent pulses may be carried out to reach a specified level of surface quality over most of the surface of metallic layer 10. The power of the laser pulses may be adjusted depending on the specific material for irradiation and its surface quality, e.g., within the range of 1 to 1000 mJ per pulse.

When the process is applied to impair or breach isolating layer 11 for further processing, laser 1902 may be operated either in a pulse mode, with high energy pulses evaporating isolating layer 11 locally to produce punctures, or laser 1902 may be operated as a continuous beam to produce one or multiple cuts on the surface of isolating layer 11. In some embodiments, an excess pressure of inert gas (e.g., up to 10 bar) may be provided into chamber 1901 to allow higher power operation of the laser without evaporation of the material for irradiation off metallic layer 10.

When the process is applied to alter a surface roughness of intermediary layer 9, laser 1902 may be operated as a continuous or modulated beam to produce desired surface roughness (e.g., up to 10 μm Rₘₐₓ) by local melting and ablation processes.

FIG. 20 is a high-level flowchart illustrating a method 150 of producing radionuclides, according to some embodiments of the invention. The method stages may be carried out with respect to systems 200 described above, which may optionally be configured to implement method 150. Method 150 may comprise the following stages, irrespective of their order.

Method 150 may comprise irradiating the disclosed irradiation target with ions from a particle accelerator (stage 160), and extracting the radionuclides from the irradiated target (stage 170).

In some embodiments, method 150 may further comprise heating the irradiation target prior to the irradiation to evaporate at least a part of the first metal enriched with a specific metal isotope—to deposit the evaporated metal onto a dedicated cooled surface (stage 155).

In some embodiments, method 150 may further comprise heating the irradiation target after the irradiation to evaporate at least a part of the irradiated first metal enriched with a specific metal isotope—to deposit the evaporated irradiated metal onto a dedicated cooled surface (stage 165).

For example, at least 60% of the evaporated metal or the evaporated irradiated metal is deposited onto the dedicated cooled surface. In various embodiments, the heating may be carried out at temperatures between 300 °C-500 °C, 500 °C-700 °C or 700 °C-1000 °C, or at intermediate values or ranges.

In some embodiments, method 150 may further comprise, after the deposition and prior to the irradiating, smoothening the deposited material by local heating and melting by a pulsed laser to yield uniform thickness of the material (stage 157).

In some embodiments, method 150 may further comprise breaching the isolating layer (stage 180) and dissolving at least part of the target (stage 190). For example, the breaching of the isolating layer may be carried out by at least one of: puncturing, scratching or scraping of the isolating layer with a sharp instrument made of hard inert material (e.g., (hardened steel, tungsten, molybdenum, tantalum, quartz, ceramics such as tungsten carbide, aluminum oxide, titanium nitride, etc.); and perforating the isolating layer by a laser beam to form punctures, cuts or grids thereof therein. Dissolving 190 may be carried out using, e.g., nitric acid, hydrochloric acid, an organic solvent, or a combination thereof, possibly mixed with water. Dissolving 190 may be further applied to the isolating layer and/or to residues to evaporated target (stage 192).

In some embodiments, the radionuclides extracted from target 1 may be further processed, e.g., implementing isotopic purification and/or mass separation methods, e.g., as described in non-limiting examples taught by U.S. Pat. No. 9,202,600, incorporated herein by reference in its entirety, to remove unwanted impurities of other radionuclides or stable isotopes of the same chemical element. Such processing may be implemented to, e.g., I-123, I-125, Tb-149, Tb-152, Lu-177 and At-211 radionuclides as non-limiting examples, to overcome possible limitation of isotopic purity of the material for irradiation by co-production of other isotopes of the same element and possibly impurities due to significant nuclear cross-sections of other nuclear reactions.

Advantageously, with respect to prior art such as U.S. Pat. Nos. 10,249,399, 11,335,473 and U.S. Patent Application Publication No. 2007/0297554, disclosed embodiments provide higher availability of specific nuclides, better yield, enhanced safety, increased efficiency of collection of the produced radionuclide, increased efficiency of usage of target material and higher purity and specific activity of the produced radionuclide. Disclosed produced radionuclides are either already used for medical applications or expected to be used as the production capacity becomes available and/or the treatment protocols are developed and approved, and are hence beneficial in various medical applications.

Advantageously, with respect to prior art such as U.S. Pat. No. 11,335,473 that uses a foil to encapsulate the material for irradiation of the target, disclosed embodiments overcome prior art disadvantages such as (i) the energy loss of the particle beam in the foil is determined by the foil thickness which generally cannot be reduced below the certain threshold of 0.02 or 0.01 mm, and (ii) energy loss of the particle beam in the foil limits the beam current which the target could receive to 100 μA or 1 mA, which in turn limits the production yield of radionuclides from irradiation.

Advantageously, disclosed embodiments allow to produce a wide variety of radionuclides within a generally similar configuration of irradiation device 50, particle accelerator 6, manufacturing and processing equipment of systems 200, therefore allowing versatile and cost-effective (due to possibility of high intensity irradiation) methods to produce the disclosed radionuclides.

Advantageously, disclosed embodiments allow to irradiate the target with the ion beam impacting at a sharp angle therefore reducing the required thickness of material for irradiation (metallic layer 10) and increasing the heat transfer efficiency while providing isolation (through encapsulation, e.g., by isolating layer 11) of the target material, due to the low effective thickness and therefore low beam energy losses in isolating layer 11.

Advantageously, disclosed embodiments allow to conduct irradiation of target 1 containing volatile material for irradiation or product material without losses of the materials during the irradiation process due to various causes such as evaporation or sublimation into vacuum, sputtering from ion bombardment, and while avoiding contamination of irradiation device 50 and the disclosed materials.

Elements from FIGS. 1-20 may be combined in any operable combination, and the illustration of certain elements in certain figures and not in others merely serves an explanatory purpose and is non-limiting. It is noted that provided values may be modified by ±10% of the respective value.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An irradiation target for producing a radionuclide by irradiation thereof with ions from a particle accelerator, the irradiation target comprising:
a metallic layer comprising a first metal enriched with a specific metal isotope,
a base plate supporting the metallic layer, and
an isolating layer covering the metallic layer on the base plate by at most 3 μm of a deposited second metal that has a vapor pressure below 1 Pa at 1200 °C,
wherein the base plate has a front surface that supports the metallic layer and a back surface, and is made of a third metal or metal alloy that has a thermal conductivity above 150 W/(m·K), and
wherein the irradiation target is configured to be set within a case of an irradiation device that irradiates the metallic layer thereof with the ions.

2. The irradiation target of claim 1, wherein a portion of the front surface of the base plate that supports the metallic layer is flat.

3. The irradiation target of claim 1, wherein the front surface comprises a pit having a curvature radius of at least 100 mm and a maximal depth of at most 0.5 mm.

4. The irradiation target of claim 1, wherein the first metal comprises one of: ytterbium, cadmium, zinc, bismuth or an alloy thereof, europium, tellurium, rubidium alloy, barium, antimony or arsenic.

5. The irradiation target of claim 1, wherein the first metal comprises at least 10 wt % of the enriched specific metal isotope.

6. The irradiation target of claim 1, wherein:
the first metal is metallic ytterbium enriched with at least 10% ytterbium-176, the ions are ionized atoms of deuterium and the produced radionuclide is lutetium-177;
the first metal is metallic cadmium enriched with at least 75% cadmium-116, the ions are ionized atoms of helium and the produced radionuclide is tin-117m;
the first metal is metallic cadmium enriched with at least 65% zinc-70, the ions are ionized atoms of deuterium and the produced radionuclide is copper-67;
the first metal is metallic bismuth or an alloy containing over 90% of bismuth by mass, enriched with at least 99% bismuth-209, the ions are ionized atoms of helium-4 and the produced radionuclide is astatine-211;
the first metal is metallic europium enriched with at least 45% europium-151, the ions are ionized atoms of helium and the produced radionuclide is terbium-149;
the first metal is metallic europium enriched with at least 45% europium-151, the ions are ionized atoms of helium and the produced radionuclide is terbium-152;
the first metal is metallic europium enriched with at least 45% europium-153, the ions are ionized atoms of helium-4 and the produced radionuclide is terbium-155;
the first metal is metallic tellurium enriched with at least 90% tellurium-122, the ions are ionized atoms of deuterium and the produced radionuclide is iodine-123;
the first metal is metallic tellurium enriched with at least 90% tellurium-124, the ions are ionized atoms of deuterium and the produced radionuclide is iodine-124;
the first metal is metallic tellurium enriched with at least 90% tellurium-125, the ions are ionized atoms of deuterium and the produced radionuclide is iodine-125;
the first metal is metallic tellurium enriched with at least 90% tellurium-130, the ions are ionized atoms of deuterium and the produced radionuclide is iodine-131;
the first metal is a rubidium alloy containing at least 75% by mass of rubidium and up to 25% by mass of indium, enriched with at least 90% rubidium-87, the ions are ionized atoms of helium-4 and the produced radionuclide is yttrium-90;
the first metal is metallic barium enriched with at least 70% barium-134, the ions are ionized atoms of helium and the produced radionuclide is cerium-134;
the first metal is metallic arsenic enriched with at least 99% arsenic-75, the ions are ionized atoms of helium and the produced radionuclide is bromine-77;
the first metal is metallic antimony enriched with at least 55% antimony-121, the ions are ionized atoms of helium and the produced radionuclide is iodine-123;
the first metal is metallic antimony enriched with at least 55% antimony-121, the ions are ionized atoms of helium and the produced radionuclide is iodine-124; or
the first metal is metallic antimony enriched with at least 40% antimony-123, the ions are ionized atoms of helium and the produced radionuclide is iodine-125.

7. The irradiation target of claim 1, wherein the metallic layer is deposited by evaporation or sublimation of heated source material in vacuum.

8. The irradiation target of claim 7, wherein the source material is a pre-fabricated sample, ingot or powder of volatile metal, having vapor pressure of 1 Pascal or higher at 800 °C.

9. The irradiation target of claim 7, wherein the source material is a previously used irradiation target having an impaired isolating layer.

10. The irradiation target of claim 1, wherein the metallic layer is deposited electrochemically, by electroplating from molten salt, acidic or alkali solution, by applying an electric current thereto.

11. The irradiation target of claim 1, wherein the metallic layer is deposited by physical vapor deposition of atoms provided by magnetron sputtering.

12. The irradiation target of claim 1, wherein the third metal or alloy thereof comprises at least one of: copper, silver, aluminum, gold or alloys thereof having over 84% by mass.

13. The irradiation target of claim 1, wherein the base plate is configured to have protrusions and/or grooves configured to accurately position the base plate during deposition of the metallic layer thereupon by evaporation of heated source material in vacuum and to prevent material losses during deposition.

14. The irradiation target of claim 1, wherein a back surface of the base plate comprises semi-spherical pits that are between 0.5 mm and 2 mm in depth, and between 2 mm and 10 mm in diameter; and/or grooves that are between 1 mm and 4 mm in depth, and between 1 mm and 4 mm in width.

15. The irradiation target of claim 1, wherein a minimal thickness of the base plate is between 0.5 mm and 2 mm, between 2 mm and 4 mm, or between 4 mm and 8 mm.

16. The irradiation target of claim 1, wherein the second metal comprises one of: titanium, aluminum, chromium, niobium, tantalum.

17. The irradiation target of claim 1, wherein the isolating layer is deposited by physical vapor deposition of atoms provided by magnetron sputtering.

18. The irradiation target of claim 1, wherein the isolating layer has a thickness above most of the metallic layer that is between 0.1 μm and 1 μm, between 1 μm and 2.5 μm, or between 2.5 μm and 4 μm.

19. The irradiation target of claim 1, wherein the isolating layer has a thickness at edges of the metallic layer that is 2 to 20 times greater than a thickness thereof above the metallic layer.

20. The irradiation target of claim 1, further comprising an intermediary layer between the front surface of the base plate and the metallic layer, the intermediary layer comprising an inert metal, is under 300 μm thick, and covers over half of the front surface.

21. The irradiation target of claim 20, wherein the inert metal comprises at least one of: gold, platinum, rhodium, nickel and niobium.

22. The irradiation target of claim 20, wherein the intermediary layer is configured to one of:
have a thickness between 5 μm and 20 μm;
have a thickness between 20 μm and 50 μm and surface roughness that are up to 10 μm Rₘₐₓ prior to deposition of the metallic layer thereupon;
have a thickness between 50 μm and 100 μm and surface roughness that are up to 20 μm Rₘₐₓ prior to deposition of the metallic layer thereupon; or
have a thickness between 100 μm and 300 μm and surface roughness that are up to 40 μm Rₘₐₓ prior to deposition of the metallic layer thereupon.
